(19) United States
(12) Patent Application Publication
(10) Pub. No.: US 2026/0305880 A1
(43) Pub. Date: Oct. 8, 2026

(54) Caddy Hanger Device

(71) Applicant: James Chavez, Albuquerque, NM (US)

(72) Inventor: James Chavez, Albuquerque, NM (US)

(21) Appl. No.: 19/171,572

(22) Filed: Apr. 7, 2025

(51) Int. Cl. A47K 3/28; F16M 13/02

(52) U.S. Cl. CPC A47K 3/281; F16M 13/02

(57) ABSTRACT

A caddy hanger device for organizing personal hygiene products within a shower includes a shower having a first wall, a second wall, and a shower head positioned on the first wall. A rod is coupled and extends from to the second wall into the shower. A shower caddy is positionable to hang from the rod wherein the shower caddy is designed to be accessible to the user while the user is standing in the shower and wherein the shower caddy is spaced from the shower head to facilitate access to both the shower caddy and the shower head while a user is standing in the shower. A channel extends inwardly through the forward surface and outwardly through the rearward surface of the rod. The channel is cylindrical. A fastener couples the rod to the second wall. The fastener extends through the channel into the second wall.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to shower caddies and more particularly pertains to a new shower caddy for organizing personal hygiene products within a shower.

### (2) Description of Related Art Including Information Disclosed Under 37 CFR 1.97 and 1.98

The prior art relates to shower caddies. Shower caddies are available in various designs to accommodate different storage needs and bathroom layouts. Hanging shower caddies, including over-the-showerhead and over-the-door models, provide convenient, space-saving storage. Freestanding caddies, such as corner units and standing shelves, offer stability and versatility. Suction cup and magnetic caddies attach to smooth surfaces without hardware, making them ideal for temporary or rental-friendly use. Adhesive and wall-mounted caddies provide a more permanent solution, either through waterproof adhesives or drilled-in installation. Portable options, such as plastic basket caddies and quick-drying mesh caddies, cater to dormitories, travel, and shared bathrooms. While these designs offer various benefits, challenges remain in optimizing durability, accessibility, and secure installation. For example, hanging caddy models are more stable than suction cup and magnetic caddies, making them preferrable for temporary or rental-friendly uses. However, over-the-showerhead models require a lot of the space under the showerhead, limiting their usefulness for tall people or cramped spaces. Over-the-door models do not work in bathtub shower combinations which do not typically have doors. Thus, there is a need for a hanging shower caddy assembly that can easily be installed to hang somewhere other than on the showerhead or the door.

### (H) BRIEF SUMMARY OF THE INVENTION

An embodiment of the disclosure meets the needs presented above by generally comprising a shower having a first wall and a second wall. A shower head is positioned on the first wall. A rod is coupled to the second wall wherein the rod is positionable to extend outwardly from the second wall into the shower and wherein the rod is designed to be accessible to a user while the user is standing in the shower. A shower caddy is positionable to hang from the rod wherein the shower caddy is designed to be accessible to the user while the user is standing in the shower and wherein the shower caddy is spaced from the shower head while the shower caddy is hanging from the rod whereby the rod is designed to facilitate access to both the shower caddy and the shower head while the user is standing in the shower. A channel extends inwardly through the forward surface and outwardly through the rearward surface of the rod. The channel is cylindrical. A fastener couples the rod to the second wall. The fastener extends through the channel into the second wall.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a caddy hanger device according to an embodiment of the disclosure.

FIG. 2 is an isometric view of an embodiment of the disclosure.

FIG. 3 is an isometric view of an embodiment of the disclosure.

FIG. 4 is a side view of an embodiment of the disclosure.

FIG. 5 is an in-use view of an embodiment of the disclosure.

### (J) DETAILED DESCRIPTION OF THE INVENTION

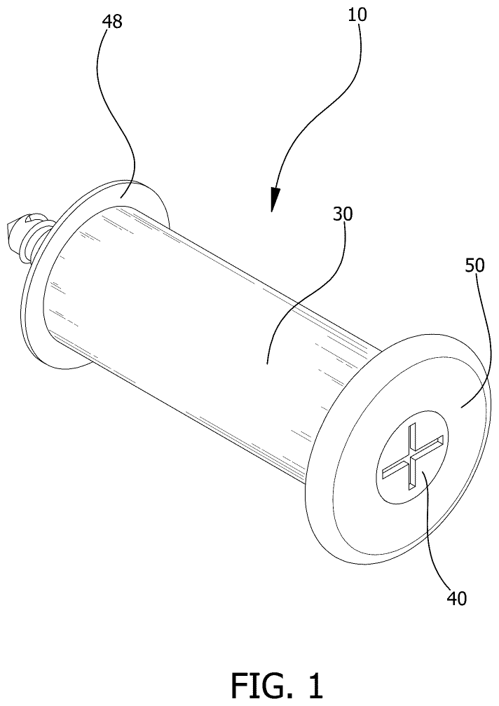

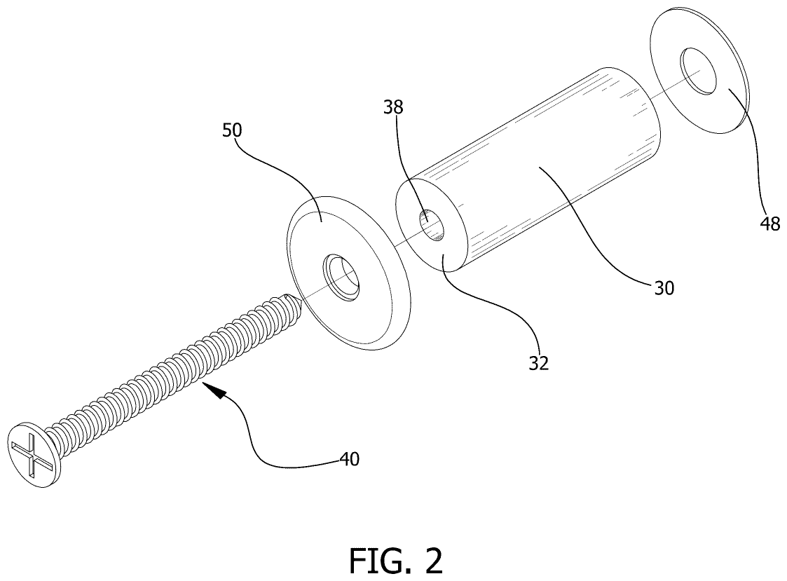

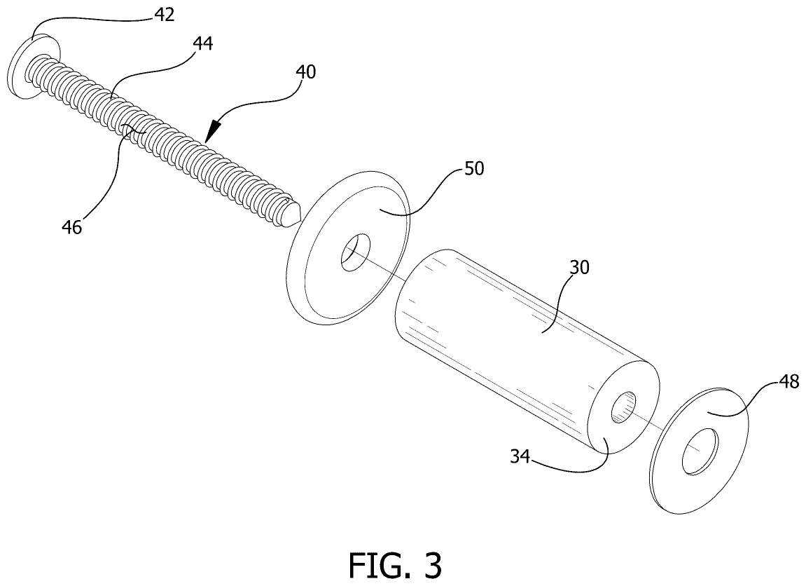

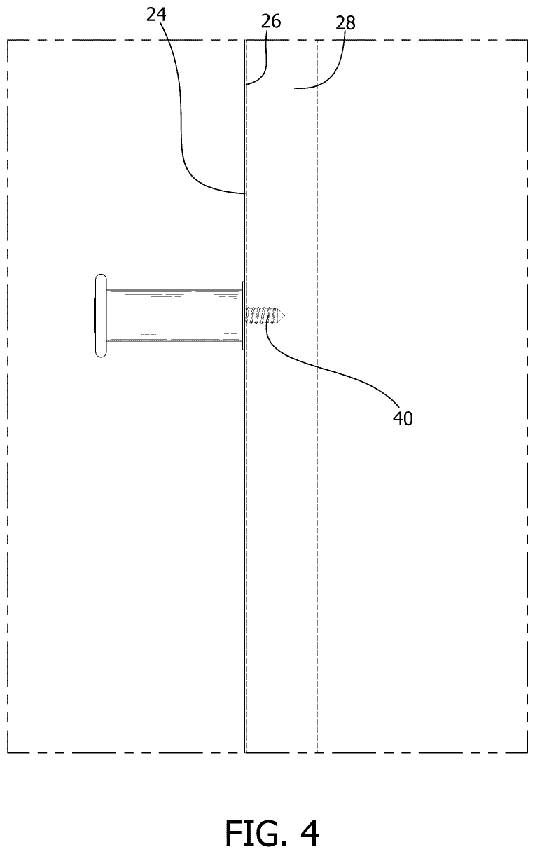

With reference now to the drawings, and in particular to FIGS. 1 through 5 thereof, a new shower caddy embodying the principles and concepts of an embodiment of the disclosure and generally designated by the reference numeral 10 will be described.

As best illustrated in FIGS. 1 through 5, the caddy hanger device 10 generally comprises a shower 12 having a first wall 14, a second wall 16, and a third wall 18 that extends between the first wall 14 and the second wall 16. The shower 12 has a shower head 20 that is positioned on the first wall 14 wherein the shower head 20 is configured to direct water 22 into the shower 12 toward the second wall 16.

The second wall 16 generally includes an exposed surface 24 facing into the shower 12. The exposed surface 24 is generally planar. A covered surface 26 faces outwardly away from the shower 12. A stud 28 may be positioned against the covered surface 26 of the second wall 16 wherein the second wall 16 is positioned between the stud 28 and the shower 12.

A rod 30 is coupled to the second wall 16. More specifically, the rod 30 is positionable to extend outwardly from the second wall 16 into the shower 12. Thus, the rod 30 is configured to be accessible to a user while the user is standing in the shower 12 under the shower head 20 and facing the second wall 16. The rod 30 may have a forward surface 32 and a rearward surface 34. The rod 30 is generally elongated between the forward surface 32 and the rearward surface 34. The rearward surface 34 may be planar wherein the rearward surface 34 is positionable flush against the exposed surface 24 of the second wall 16. The rod 30 is typically perpendicular to the second wall 16.

A shower caddy 36 is positionable to hang from the rod 30 wherein the shower caddy 36 is configured to be accessible to the user while the user is standing in the shower 12. The shower caddy 36 is spaced from the shower head 20 while the shower caddy 36 is hanging from the rod 30 whereby the rod 30 is configured to facilitate access to both the shower caddy 36 and the shower head 20 while the user is standing in the shower 12.

A channel 38 extends inwardly through the forward surface 32 and outwardly through the rearward surface 34 of the rod 30. The channel 38 may be cylindrical. A fastener 40 may couple the rod 30 to the second wall 16. The fastener 40 extends through the channel 38 and the second wall 16. The fastener 40 may extend into the stud 28 wherein the stud 28 is configured to secure a position of the rod 30 on the second wall 16 while the fastener 40 couples the rod 30 to the second wall 16.

The fastener 40 may include a head 42, which generally has a diameter exceeding a diameter of the channel 38. The forward surface 32 of the rod 30 may therefore inhibit the head 42 from being positioned within the channel 38. A body 44 extends from the head 42. The body 44 has a diameter that is less than a diameter of the channel 38 wherein the body 44 is positionable to extend through the channel 38. The body 44 also generally has a length exceeding a distance between the forward surface 32 and the rearward surface 34 of the rod 30 such that the body 44 extends outwardly past the rearward surface 34 of the rod 30 when the head 42 of the fastener 40 is positioned against the forward surface 32. The body 44 may have a threaded outer surface 46 wherein the fastener 40 is threadably couplable to the second wall 16 and the stud 28.

A guard 48 may be positionable between the rearward surface 34 of the rod 30 and the exposed surface 24 of the second wall 16. The guard 48 inhibits the rod 30 from damaging the exposed surface 24 of the second wall 16 while the rod 30 is coupled to the second wall 16. The fastener 40 typically extends through the guard 48 into the second wall 16. For example, the guard 48 may be a washer.

A stop 50 may be positionable between the forward surface 32 of the rod 30 and the head 42 of the fastener 40. The stop 50 may have a diameter exceeding a diameter of the rod 30 wherein the stop 50 secures the shower caddy 36 on the rod 30.

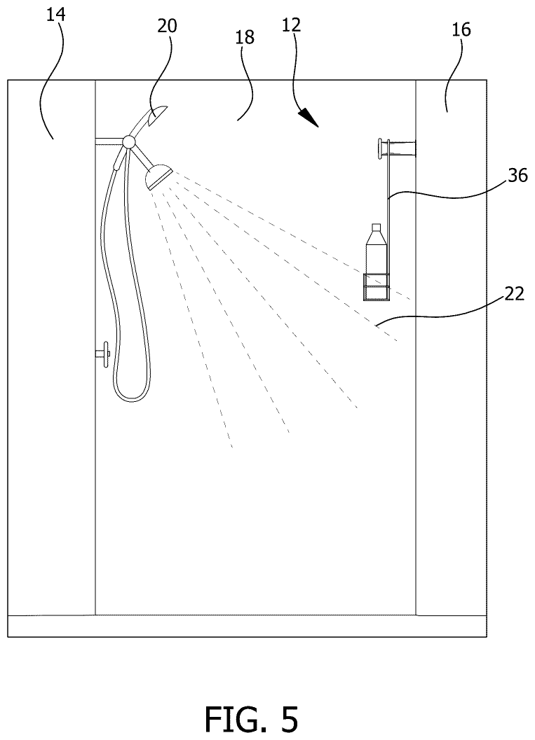

In use, the caddy hanger device 10 can be installed in nearly any shower 12. The fastener 40 secures the rod 30 to the second wall 16, across from the shower head 20, as shown in FIG. 5. In some alternative embodiments, the rod 30 may also be coupled to the third wall 18. The user can then access items stored in the shower caddy 36 while facing the second wall 16 and standing beneath the shower head 20. The user does not need to turn and face the shower head 20, and the shower caddy 36 does not block access to the shower head 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hanger system comprising:
a shower having a first wall and a second wall, the shower having a shower head being positioned on the first wall;
a rod being coupled to the second wall wherein the rod is positionable to extend outwardly from the second wall into the shower and wherein the rod is configured to be accessible to a user while the user is standing in the shower;
a shower caddy being positionable to hang from the rod wherein the shower caddy is configured to be accessible to the user while the user is standing in the shower and wherein the shower caddy is spaced from the shower head while the shower caddy is hanging from the rod whereby the rod is configured to facilitate access to both the shower caddy and the shower head while the user is standing in the shower;
a channel extending inwardly through the forward surface and outwardly through the rearward surface of the rod; and
a fastener coupling the rod to the second wall, the fastener extending through the channel into the second wall.

2. The hanger system of claim 1, the rod further comprising a forward surface and a rearward surface, the rearward surface being planar wherein the rearward surface is positionable flush against the second wall.

3. The hanger system of claim 2, wherein the rod is elongated between the forward surface and the rearward surface.

4. The hanger system of claim 1, wherein the rod being perpendicular to the second wall.

5. The hanger system of claim 1, wherein the channel is cylindrical.

6. The hanger system of claim 1, wherein the fastener extends into a stud positioned behind the second wall relative to the first wall whereby the fastener is configured to secure a position of the rod on the second wall.

7. The hanger system of claim 1, the fastener further comprising:
a head having a diameter exceeding a diameter of the channel; and
a body extending from the head, the body having a diameter being less than a diameter of the channel wherein the body is positionable to extend through the channel.

8. The hanger system of claim 7, wherein the body has a threaded outer surface wherein the fastener is threadably couplable to the second wall.

9. The hanger system of claim 1, further comprising a guard being positionable between the rod and the second wall wherein the guard inhibits the rod from damaging the second wall while the rod is coupled to the second wall.

10. The hanger system of claim 9, wherein the fastener extends through the guard into the second wall.

11. The hanger system of claim 1, further comprising a stop being positionable between the rod and the head of the fastener.

12. The hanger system of claim 11, wherein the stop has a diameter exceeding a diameter of the rod wherein the stop secures the shower caddy on the rod.

13. A hanger system comprising:
a shower having a first wall, a second wall, and a third wall extending between the first wall and the second wall, the shower having a shower head being positioned on the first wall wherein the shower head is configured to direct water into the shower toward the second wall, the second wall including:
an exposed surface facing into the shower, the exposed surface being planar; and
a covered surface facing outwardly away from the shower;
a stud being positioned against the covered surface of the second wall wherein the second wall is positioned between the stud and the shower;
a rod being coupled to the second wall wherein the rod is positionable to extend outwardly from the second wall into the shower and wherein the rod is configured to be accessible to a user while the user is standing in the shower, the rod having a forward surface and a rearward surface, the rod being elongated between the forward surface and the rearward surface, the rearward surface being planar wherein the rearward surface is positionable flush against the exposed surface of the second wall, the rod being perpendicular to the second wall;
a shower caddy being positionable to hang from the rod wherein the shower caddy is configured to be accessible to the user while the user is standing in the shower and wherein the shower caddy is spaced from the shower head while the shower caddy is hanging from the rod whereby the rod is configured to facilitate access to both the shower caddy and the shower head while the user is standing in the shower;
a channel extending inwardly through the forward surface and outwardly through the rearward surface of the rod, the channel being cylindrical;
a fastener coupling the rod to the second wall, the fastener extending through the channel and the second wall into the stud wherein the stud is configured to secure a position of the rod on the second wall while the fastener couples the rod to the second wall, the fastener including:
a head having a diameter exceeding a diameter of the channel wherein the forward surface of the rod inhibits the head from being positioned within the channel; and
a body extending from the head, the body having a diameter being less than a diameter of the channel wherein the body is positionable to extend through the channel, the body having a threaded outer surface wherein the fastener is threadably couplable to the second wall and the stud;
a guard being positionable between the rearward surface of the rod and the exposed surface of the second wall wherein the guard inhibits the rod from damaging the exposed surface of the second wall while the rod is coupled to the second wall, the fastener extending through the guard into the second wall, the guard being a washer; and
a stop being positionable between the forward surface of the rod and the head of the fastener, the stop having a diameter exceeding a diameter of the rod wherein the stop secures the shower caddy on the rod.
